(19) United States
(12) Patent Application Publication
(10) Pub. No.: US 2002/0069356 A1
(43) Pub. Date: Jun. 6, 2002

(54) Integrated security gateway apparatus

(76) Inventor: Kwang Tae Kim, Seongnam-si (KR)

Correspondence Address: PENNIE AND EDMONDS, 1155 AVENUE OF THE AMERICAS, NEW YORK, NY, 100362711

(21) Appl. No.: 09/784,719

(22) Filed: Feb. 14, 2001

(30) Foreign Application Priority Data
Dec. 6, 2000 (KR) 2000-32182

(51) Int. Cl. H04L 9/00

(52) U.S. Cl. 713/160

(57) ABSTRACT

A networking system of the present invention is associated with an integrated security gateway for integrating virtual private networking, firewall, and network monitoring functions. A duplicate of a received packet is provided to a network monitoring system connected thereto or included therein so as to detect all kind of intrusions and attacks to a virtual private network and the integrated security gateway itself. And, by implementing a variety of functions and services in the network monitoring system, the network system of the present invention can enjoy almost complete security.

### BACKGROUND OF THE INVENTION

1. Field of the Invention

The present invention relates to a networking system for wide-area networking. In particular, the invention relates to a networking system with an integrated security gateway apparatus interposed between an internal network and an external network, for integrating virtual private networking, firewall and intrusion detection functions.

2. Description of the Related Art

Businesses today are faced with supporting a broader variety of communications among a wider range of corporate branches even as they seek to reduce the cost of their communications infrastructure. Employees are looking to access the resources of their corporate intra-nets as they take to the road or telecommute. And also, business partners are joining together in extra-nets to share business information. In this environment, private computer networks come in all forms and are put to many purposes.

FIG. 1 shows an example of a conventional private computer network using dedicated leased lines or packet-based networks to connect corporate branches through routers. One of the most disadvantageous features of this solution is that such private computer networking does not provide the flexibility required for quickly creating new partner links or supporting project teams in the field.

On the other hand, the corporate can enjoy the security of the private computer network via access control and encryption, while taking advantage of the economies of scale and built-in management facilities of large public networks. For example, the point-to-point tunneling protocol (PPTP) that encapsulates other protocol for transmission over an IP (Internet Protocol) network is used to create a VPN (Virtual Private Network) within the public Internet. The VPN allows a network manager to connect corporate remote branch sites and/or project teams to the corporate main branch economically and provides remote access to employees, which reduces the in-house requirements for equipment and support. That is, an Internet-based VPN uses the open, distributed infrastructure of the Internet to transmit data between corporate branches.

Since each of the corporate branches is connected to the Internet in the Internet-based VPN, information can be exchanged between the VPN users and the Internet users. This information exchange presents a challenge to protect information located on the corporate branches from unauthorized access by the Internet users and from unauthorized export by the VPN users. For example, crackers have been able to erase files or disks, cancel programs, retrieve sensitive information and even introduce computer viruses, Trojan horses and/or worms into the corporate main branch.

A firewall is a technique for keeping a network secure. The firewall is widely used to separate corporate public resources, e.g., DMZ (Demilitarized Zone) servers including a corporate public Web server, mail server and etc, from a corporate internal network as well as to give the VPN users access to the Internet in a secure fashion.

FIG. 2 shows an example of a conventional internet-based VPN using the Internet to connect VPN branches through VPN proxies, firewalls and the routers. Each of the firewalls 280, 290 is coupled to corresponding one of the VPN proxies 260, 270 and to corresponding one of corporate DMZ servers 214, 224. The VPN proxies 260, 270 generally perform encryption and decryption to protect data against eavesdropping and tampering by unauthorized parties.

Each of the firewalls 280, 290 receives an incoming packet from the corresponding router 240 or 250 and checks whether the incoming packet could be sent to the VPN branches 210, 220 and the DMZ servers 214, 224 by using a predetermined rule. For example, the firewall checks whether the incoming packet is from a valid domain or IP address, i.e., an identified external resource.

Referring to FIGS. 3A and 3B, there are provided other conventional Internet-based VPNS, each of which further comprises an IDS (intrusion detection system) 370 interposed between the router 340 and the firewall 350 or an IDS 380 between the VPN site 310 and the VPN proxy 360. Except that the IDS 370 or 380 is inserted, the VPNs 301, 302 in FIGS. 3A and 3B are substantially identical to the VPN 2 in FIG. 2. The IDS 370, 380 performs real-time intrusion detection into the VPN branch by including an intrusion pattern database and an expert system, which can be implemented by software or hardware.

The IDSs 370, 380 perform functions of traffic control, real time monitoring and intrusion detection, intrusion blocking, intrusion analysis and reporting. In FIG. 3A, since the IDS 370 is interposed between the router 340 and the firewall 350, the IDS 370 can detect an intrusion into the firewall 350 or the internal network 310. However, in this case, the IDS 370 itself could be attacked by an external intruder. On the contrary, in FIG. 3B, since the IDS 380 is interposed between the VPN branch 310 and the VPN proxy 360, intrusion detection is done only for the packet that is passed through the firewall 350. That is, the IDS 380 cannot detect an intrusion exactly because the firewall 350 drops packets that are not accepted. Therefore, the intruder can attack the firewall 350 or the internal network 200 and abuse network resources continuously.

Furthermore, because the VPN proxy, the firewall and the IDS are constructed separately, a security hole problem tends to frequently occur as well as costly installation.

### SUMMARY OF THE INVENTION

It is, therefore, an object of the present invention to provide an integrated security gateway for integrating virtual private networking and firewall functions.

Another object of the present invention is to provide an integrated security gateway for integrating intrusion detection functions as well as virtual private networking and firewall functions.

In accordance with one aspect of the present invention, there is provided an integrated security gateway apparatus interfacing with an internal network and an external network for blocking a selected packet from the internal network or external network, comprising a packet duplicating module for receiving and duplicating an incoming packet from one of the internal and external networks, a black zone server coupled to the packet duplicating module for analyzing the duplicated packet, and an inspection engine coupled to the packet duplicating module and the block zone server for inspecting whether the received incoming packet corresponds to the selected packet to be blocked based on the analysis in the block zone server, wherein the black zone server serves as at least one of an intrusion detection system, an anti-virus system and a noxious site blocking system.

In accordance with another aspect of the present invention, there is provided a networking system consisting of at least one internal network and an external network, comprising an integrated security gateway interfacing with at least one internal network and the external network for receiving and duplicating an incoming packet from one of the internal and external networks, and a black zone server coupled to the integrated security gateway for analyzing the duplicating packet, the integrated security gateway inspecting whether the received incoming packet is to be denied based on the analysis in the black zone server.

### BRIEF DESCRIPTIONS OF THE DRAWINGS

The above and other objectives and features of the present invention will become apparent from the following description of embodiments given in conjunction with the accompanying drawings, in which:

FIG. 1 is a schematic diagram of a conventional private computer network using dedicated leased lines or packet-based networks.

FIG. 2 shows a schematic diagram of an Internet-based VPN;

FIGS. 3A and 3B offer schematic diagrams of conventional other Internet-based VPNS;

FIG. 4 illustrates a schematic diagram of a VPN employing an integrated security gateway in accordance with the present invention;

FIG. 5 provides a hardware block diagram of an integrated security gateway in FIG. 4;

FIG. 6 shows a functional block diagram of an integrated security gateway in FIG. 4; and

FIGS. 7A and 7B are flow charts for explaining details of an integrated security gateway in accordance with the present invention.

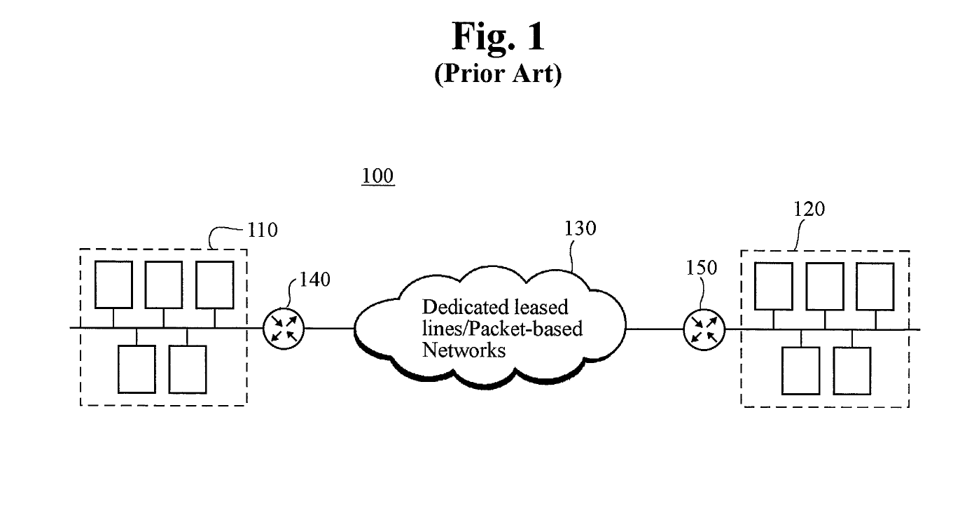

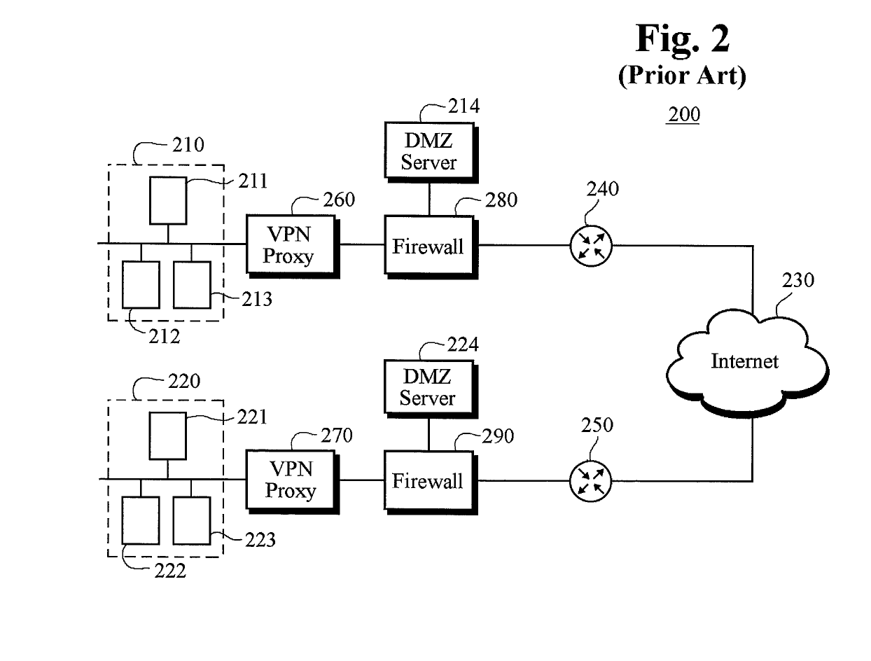

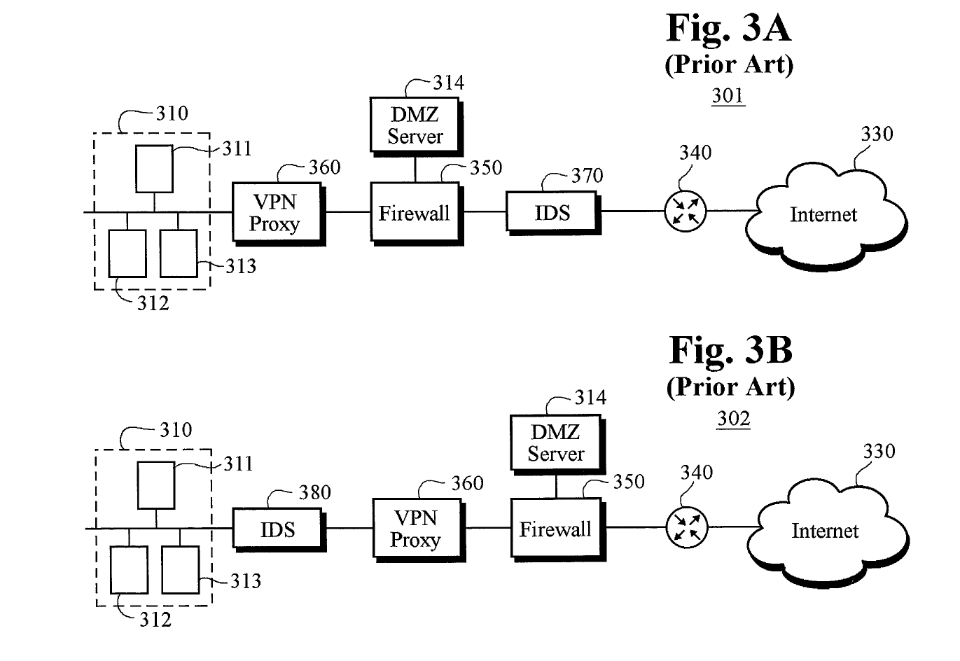

### DETAILED DESCRIPTION OF THE PRESENT INVENTION

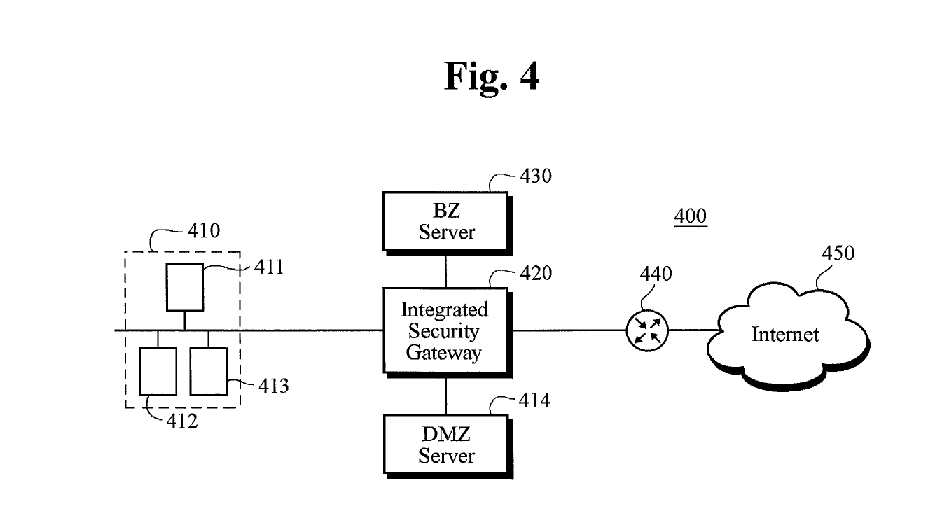

Referring to FIG. 4, there is provided a schematic diagram of a VPN (Virtual Private Network) employing an integrated security gateway in accordance with the present invention. The VPN is comprised of a plurality of internal networks 410 each of which is connected to an external network such as the Internet via a router 440. For the sake of simplicity, only one internal network is shown.

The internal network 410 is connected to the router 440 through an inventive integrated security gateway 420 to which a “demilitarized zone (DMZ)” server and a “black zone (BZ)” server are connected. The DMZ server is a Web server and/or a mail server. The internal network 410 may be a local area network. In FIG. 4, the internal network 410 is illustrated as including a server computer 411 and two client computers 412, 413, for the sake of simplicity.

The integrated security gateway 420 protects the internal network 410 from outsiders. It also prevents unauthorized transmission of data/information stored in the internal network computers to outside.

The integrated security gateway 420 protects the DMZ server 414 from an attack from the external network 450.

The integrated security gateway 420 provides data encryption and decryption for which variable encryption rules can be applied depending on IP (Internet Protocol) addresses or ports. The key to data encryption and decryption can be established or updated in the integrated security gateway 420 by a well-known external input device, e.g., a smart card.

The integrated security gateway 420 provides packet filtering by employing Stateful Inspection, i.e., by inspecting the state of the current input packet with respect to the state of the previous input packet in an application. And a number of filtering rules can be applied depending on the IP addresses or the ports. The integrated security gateway 420 performs static packet filtering, i.e., checking the input packet under a predetermined filtering rule.

The integrated security gateway 420 performs URL (Uniform Resource Locator) filtering in a restrictive mode in which selected packets are to be passed or in a permissive mode in which all the packets except for a selected few are to be passed. The integrated security gateway 420 also performs packet contents filtering.

The integrated security gateway 420 provides a virtual session for a UDP (User Datagram Protocol) application to solve a security problem associated with connectionless packet transfer. The virtual session contains and updates UDP connection information dynamically.

The integrated security gateway 420 generates a session for only a permitted RPC (Remote Procedure Call) service in which a port number of a packet source is changed dynamically and performs ICMP (Internet Control Message Protocol) redirect blocking, IP source routing blocking, and static routing. The integrated security gateway 420 provides NAT (network address translation).

A BZ server 430, coupled to the integrated security gateway 420 acts as an IDS (Intrusion Detection System), performing traffic control, real time monitoring, and intrusion detection, intrusion blocking and intrusion analysis and reporting. As will be described below, the BZ server 430 is invisible to the users of the internal network 410 and the external network 450 so as to maximize security. In other words, the gateway copies all the incoming packets from the internal network 410, the DMZ server 414 and the external network 450 and sends them to the BZ server 430. Then, the BZ server 430 analyzes the duplicated packets from the integrated security gateway 420 and reports its analysis to the integrated security gateway 420 so that the integrated security gateway 420 can process the input packet depending on the analysis result.

The BZ server 430 may act as an anti-virus system for blocking packets infected with virus and/or as a blocking system for blocking packets from selected Web sites.

It may be a hub to which the IDS, the anti-virus system and/or the site blocking system may be coupled so that intrusion protection, virus checking and/or site blocking can be performed.

The integrated security gateway 420 itself may include a built-in BZ server at which the duplicated input packets are analyzed.

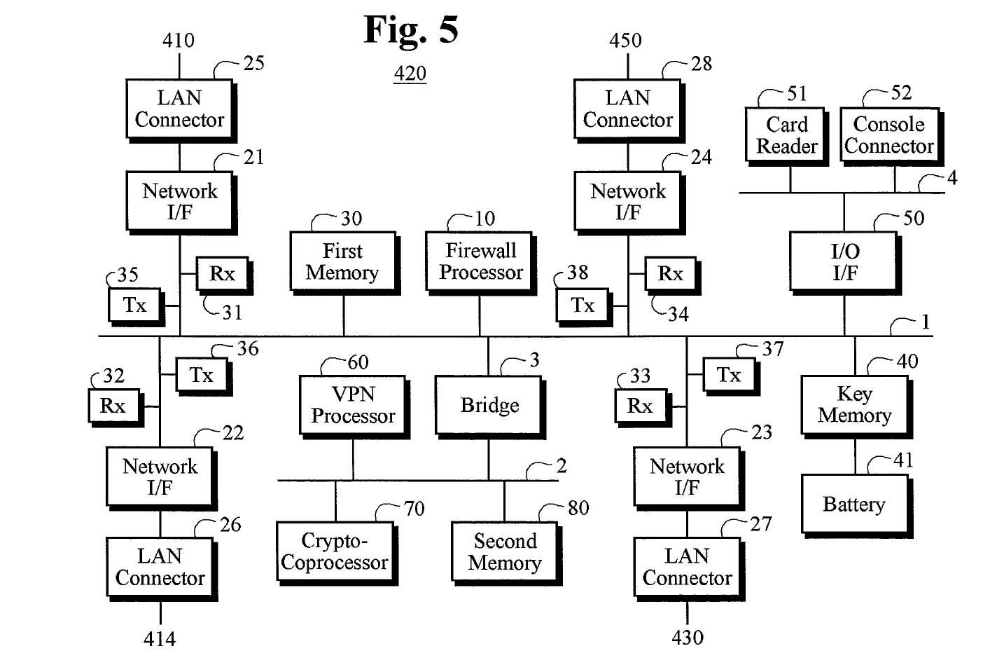

FIG. 5 provides a hardware block diagram of an embodiment of an integrated security gateway in FIG. 4.

As shown in FIG. 5, the integrated security gateway 420 includes a firewall processor 10, four network interface cards 21, 22, 23, 24, a first memory 30, a key memory 40 and an I/O (input/output) interface card 50, all connected to a first bus 1. The integrated security gateway 420 further includes a VPN processor 60, a crypto-coprocessor 70 and a second memory 80, all connected to a second bus 2 which in turn is connected to the first bus 1 through a bus bridge 3.

Each of the network interface cards 21, 22, 23, 24 is coupled to a corresponding one of LAN (local area network) connectors 25, 26, 27, 28, a corresponding one of Rx (receiving) buffers 31, 32, 33, 34 and a corresponding one of Tx (transmitting) buffers 35, 36, 37, 38. The network interface cards 21, 22, 23, 24 are used to interface with the internal network 410, the DMZ server 414, the BZ server 430 and the external network 450 in FIG. 4, respectively. The network interface cards 21, 22, 23, 24 are designed to meet the Institute of Electrical and Electronics Engineers (IEEE) standard 802.3 titled “Carrier Sense Multiple Access with Collision Detection (CSMA/CD) access method and Physical layer specifications”. It can be appreciated, however, that the network interface cards 21, 22, 23, 24 designed to work with other medium access techniques or standards could be used in the present invention.

The Rx buffers 31, 32, 33 are used to store incoming packets received respectively from the internal network 410, the DMZ server 414, the BZ server 430 and the external network 450 until the incoming packets can be processed by the processors 10, 60.

The Tx buffers 35, 36, 37, 38 are used to store outgoing packets until the outgoing packets can be sent respectively to the internal network 410, the DMZ server 414, the BZ server 430, and the external network 450.

Each of the firewall processor 10 and the VPN processor 60 can be a dedicated high performance microprocessor. Any microprocessor capable of operating at a speed required to implement the functions as described above and will be described in detail below is appropriate.

The first memory 30 is used to store the packet, an OS (operating system), OS parameters, pre-defined parameters, IP addresses, and etc. The first memory 30 includes several types of high speed memory devices such as a DIMM type 64-512 Mbyte SDRAM, a flash type 4-8 Mbyte ROM. The first memory 30 further stores instructions for controlling actions to take on the incoming and outgoing packets. These instructions include a predetermined set of criteria based upon the fields of the incoming packets and other information such as the time of day at which the incoming packet was sent or received, and the state of the session. Such criteria can be implemented by inspecting the fields of the incoming packets, by reference to external data such as a connection status and the time of day and by reference to pre-defined tables or other information stored in the first memory 30. The application of the criteria leads one or several pre-defined actions to be taken on the incoming packet.

The VPN processor 60 performs tunneling using the IPSec (Internet Protocol Security) protocol, data encryption/decryption and packet authentication. It should be appreciated that the VPN processor 60 and the firewall processor 10 can be implemented by a single micro-processor or by a multiplicity of micro-processors in the present invention.

The crypto-coprocessor 70 is used to perform computation for data encryption/decryption and packet authentication. Preferably, the crypto-coprocessor 70 is implemented by an ASIC (Application-Specific Integrated Circuit) supporting an algorithm for the data encryption and hash functions for the packet authentication employed in the VPN 400 of the present invention.

The second memory 80 is used to store the packet transferred from the first memory 30 through the bus bridge 3, and encryption and decryption rules for each IP address and port.

The key memory 40 is used to store the key for encryption/decryption and includes a SRAM type memory device. The key memory 40 is coupled to a battery 41 for protection in a stoppage of electric current.

The I/O interface card 50 is coupled to an IC card reader 51 and a console port 52 via an I/O bus 4.

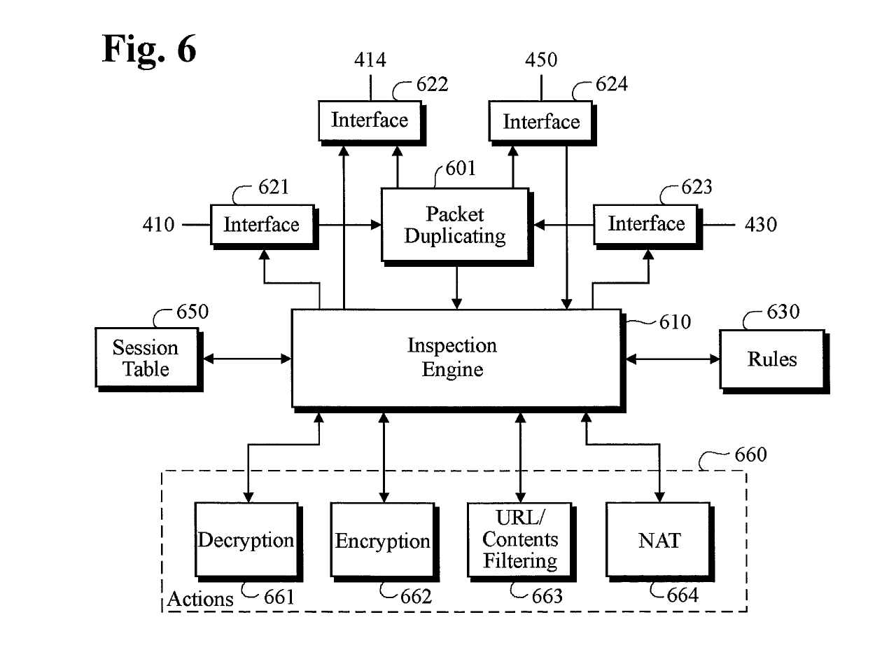

FIG. 6 shows a functional block diagram of an integrated security gateway in FIG. 4. In one embodiment, these modules are program instruction modules stored in memories and executed by the processors. The connections shown in FIG. 6 refer to software instructions or hardware instructions or both, depending on the particular physical implementation of the invention.

The gateway also includes a packet duplicating module 601 and an inspection engine 610, four network interfaces 621, 622, 623, 624 in the integrated security gateway 400. Further included are a rule storage 630, a session table 650 and an action module 660 in the integrated security gateway 400. The action module 660 includes a number of modules, e.g., an encryption module 661, a decryption module 662, a URL/contents filtering module 663 and a NAT module 664.

Each of the network interfaces 621, 622, 623, 624 performs interface with the internal network 410, the DMZ server 414, the BZ server 430 and the external network 450, respectively, preferably under the specification of the IEEE standard 802.3.

The packet duplicating module 601 is coupled to the network interfaces 621, 622, 624 to receive the incoming packet from the internal network 410, the DMZ server 414 and the external network 450 via the network interface modules, respectively. The packet duplicating module 601 is coupled to the inspection engine 610 to transfer the received packet to the inspection engine 610. On the other hand, the packet duplicating module 601 duplicates the incoming packet and transfers the duplicated packet to the BZ server 430.

The rule storage 630 is used to store instructions for inspection rules. The inspection rules are updated based on the analysis in the BZ server 430.

The session table 650 is used to store session information for states of the sessions.

The inspection engine 620 inspects the fields of the packet by using the inspection rules retrieved in the rule storage 630 and passes them to one of the action modules to execute appropriate operations on the incoming packet or to abandon the incoming packet.

On the other hand, the inspection engine 620 retrieves the session corresponding to the incoming packet in the session table 650 and extracts IP header information and TCP (Transmission Control Protocol) header information to refer and update the session status.

The decryption module 661 performs decryption on the incoming packet whose source is another VPN branch (not shown) connected to the external network 450.

The encryption module 662 performs encryption on the outgoing packet whose destination is another VPN branch (not shown) connected to the external network 450.

The URL/contents filtering module 663 performs typical URL/contents filtering functions to prevent access to a predetermined group of URLs and to drop the packet containing noxious contents.

The NAT module 664 performs a typical NAT function, e.g., by processing the proxy address resolution protocol to translate the source and the destination addresses between the internal network 410 and the external network 450.

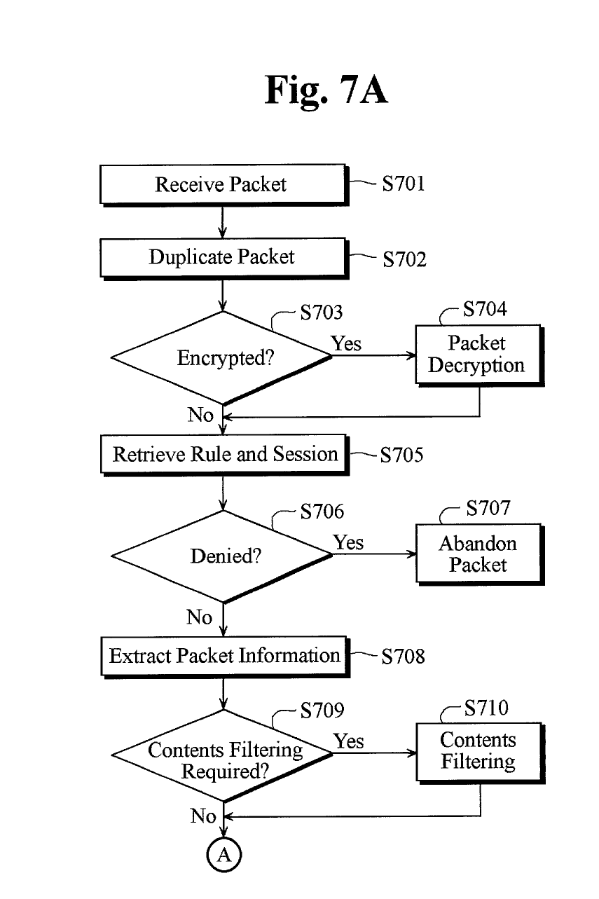

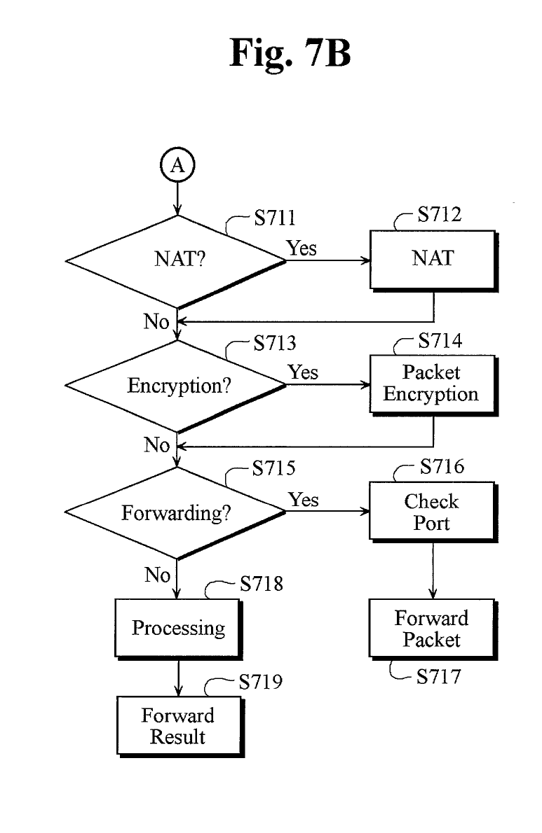

FIGS. 7A and 7B are flow charts for explaining details of an integrated security gateway.

The operation of the integrated security gateway 420 as shown in FIGS. 4 to 6 will be discussed in detail below in connection with FIGS. 7A and 7B, but it should be understood that other embodiments can be proposed without departing the range of the present invention. Each of the operations, actions or functions can be implemented as program instructions or modules, hardware, e.g., ASIC or other circuitry, ROMs, etc., or some combinations thereof.

Referring to FIG. 7A, at step S701, when the packet is received by the packet duplicating module 601, it is transferred to the inspection engine 610.

At step S702, the packet received via one of the network interface modules 621, 622, 624 is duplicated and transferred to the BZ server 430 through the network interface module 623, and then the procedure proceeds to step S703.

At step S703, the inspection engine 610 checks whether the packet is encrypted; if the packet is encrypted, the procedure proceeds to step S704, and, otherwise, the procedure proceeds to step S705.

At step S704, the packet is decrypted at the decryption module 661, and then the procedure proceeds to step S705.

At step S705, the inspection engine 610 retrieves rule and session information corresponding to the packet in the rule storage 630 and the session table 650, and then the procedure proceeds to step S706.

At step S706, the inspection engine 610 determines whether the packet is to be denied depending on the retrieved rule and the session information; if the packet is to be denied, the procedure proceeds to step S707, and, otherwise, the procedure proceeds to step S708.

At step S707, the inspection engine 610 abandons the packet and then the procedure is ended.

At step S708, the inspection engine 610 extracts the packet information and updates the session information in the session table 650, and then the procedure proceeds to step S709.

At step S709, the inspection engine 610 determines whether packet contents filtering is required; if the content filtering is required, the procedure proceeds to step S710, and, otherwise, the procedure proceeds to step S711 through tap A.

At step S710, the URL/contents filtering module 663 performs contents filtering for the packet, and then the procedure proceeds to S711.

At step S711, the inspection engine 610 determines whether NAT is required; if NAT is required, the procedure proceeds to step S712, and, otherwise, the procedure proceeds to step S713.

At step S712, the NAT module 664 performs a NAT function on the packet, and then the procedure proceeds to step S713.

At step S713, the inspection engine 610 determines whether encryption is required; if encryption is required, the procedure proceeds to step S714, and, otherwise, the procedure proceeds to step S715.

At step S714, the packet is encrypted at the encryption module 662, and then the procedure proceeds to step S715.

At step S715, the inspection engine 610 determines whether the packet is to be forwarded to outside; if the packet is to be forwarded, the procedure proceeds to step S716, and, if the packet is to be processed within the integrated security engine 420, the procedure proceeds to step S718.

At step S716, the inspection engine 610 checks a corresponding port, and then the procedure proceeds to step S717.

At step S717, the inspection engine 610 forwards the packet to the corresponding port via the corresponding network interface module, e.g., the interface module 621 connected to the internal network 410, and then the procedure is ended.

At step S718, the inspection engine 610 processes a predetermined processing, e.g., updating a list of the blocked URLs stored at the rule storage 630, and then the procedure proceeds to step S719.

At step S719, the inspection engine 610 forwards the processing result to the destination of the packet, e.g., the BZ server 430.

As described above, the duplicated incoming packet is provided to the BZ server 430 connected to or included in the integrated security gateway 420 so as to detect all kinds of intrusions and attacks to the internal network 410 and the integrated security gateway 420 itself.

Furthermore, by implementing a variety of functions and services in the BZ server 430, the VPN 400 of the present invention can enjoy almost complete security.

While there has been described and illustrated one embodiment of the present invention, it will be apparent to those skilled in the art that variations and modifications are possible without deviating from the broad principles and teachings of the present invention which should be limited solely by the spirit and scope of the claims appended hereto.

What is claimed is:

1. An integrated security gateway apparatus interfacing with an internal network and an external network for blocking a selected packet from the internal network or external network, comprising:
a packet duplicating module for receiving and duplicating an incoming packet from one of the internal and external networks;
a black zone server coupled to the packet duplicating module for analyzing the duplicated packet; and
an inspection engine coupled to the packet duplicating module and the block zone server for inspecting whether the received incoming packet corresponds to said selected packet to be blocked based on the analysis in the block zone server,
wherein said black zone server serves as at least one of an intrusion detection system, an anti-virus system and a noxious site blocking system.

2. The apparatus of claim 1, wherein the external network is the Internet.

3. The apparatus of claim 1, wherein said internal network is a local area network.

4. The apparatus of claim 1, further comprising encrypting/decrypting means for encrypting the received incoming packet if said received packet is from the internal network to the external network and decrypting otherwise.

5. The apparatus of claim 4, wherein said encrypting/decrypting means uses different keys depending on the source and the destination of the received packet.

6. A networking system consisting of at least one internal network and an external network, comprising:
an integrated security gateway interfacing with said at least one internal network and said external network for receiving and duplicating an incoming packet from one of the internal and external networks; and
a black zone server coupled to the integrated security gateway for analyzing the duplicating packet,
said integrated security gateway inspecting whether the received incoming packet is to be denied based on the analysis in the black zone server.

7. The system of claim 6, wherein the external network is the Internet.

8. The system of claim 6, wherein said internal network is a local area network.

9. The system of claim 6, wherein said integrated security gateway encrypts the received packet if said received packet is from the internal network to the external network and decrypts otherwise.

10. The system of claim 9, wherein said integrated security gateway uses different keys depending on the source and the destination of the received packet.
